(19) United States
(12) Patent Application Publication
(10) Pub. No.: US 2007/0043713 A1
(43) Pub. Date: Feb. 22, 2007

(54) VIDEO DIRECTORY

(75) Inventors: Brian S. Elmi, San Diego, CA (US); Faraz Yaghouti, San Diego, CA (US)

Correspondence Address: WILSON SONSINI GOODRICH & ROSATI, 650 PAGE MILL ROAD, PALO ALTO, CA, 94304-1050, US

(73) Assignee: Videonary, L.L.C.

(21) Appl. No.: 11/533,340

(22) Filed: Sep. 19, 2006

Related U.S. Application Data
(63) Continuation-in-part of application No. 11/203,476, filed on Aug. 12, 2005.

(51) Int. Cl. G06F 17/30

(52) U.S. Cl. 707/3

(57) ABSTRACT

An online video directory is provided. The video directory provides a means for providing video to a consumer in order to aid the consumer in making consumption choices. In particular, the video directory provides a database of advertiser records that is searchable by a consumer. The database is searchable based upon pre-defined or consumer-defined search criteria. The result of a database search is an answer set that provides consumer-selectable objects, at least one of which may be thumbnail image of a frame from a video that provides an overview of the advertiser's product and/or service offerings. Selection of the consumer-selectable object (e.g. the thumbnail) by the consumer allows the consumer to view the video as well as optionally additional advertising material. Such additional advertising material may include consumer-selectable coupons that may be delivered to the consumer by email, html, MMS, text message on a cellular phone, etc. The invention further provides an advertiser interface that provides the advertiser useful demographic data on consumers who view their videos or select their coupons.

### CROSS-REFERENCE

This application is a continuation/continuation-in-part application of Ser. No. 11/203,476, filed Aug. 12, 2005, which is incorporated herein by reference in its entirety and to which application we claim priority under 35 USC § 120.

### FIELD OF THE INVENTION

A Video Directory for places, locations and/or services and a user interface for searching the directory and displaying the result(s).

### BACKGROUND OF THE INVENTION

The present invention relates to “yellow page”-type directories, and more particularly to directories based on the Internet World Wide Web infrastructure for personal computer, mobile phone, vehicle navigation system or similar user device.

Online directories are well known. Such directories frequently provide a computer user with a graphical user interface for searching a database, which contains text-based information such as phone number, address and category relating to various types of business establishments. A very limited number of such directories may also contain an image representing various types of business establishments.

One of the most pressing problems associated with advertising is the problem of matching up a willing buyer or consumer with the right or desired product or service. For consumers, this problem may result in the consumer choosing a product or service only to find out later that the product or service is not precisely what the consumer thought it would be. For example, a user may choose a restaurant from a hard copy yellow pages book based upon a three inch ad, only to find that the restaurant is too expensive, too noisy, too quiet, not sufficiently distinctive, too formal, too casual, too crowded, not intimate enough, or in some other way not in line with the consumer's expectations. From the advertiser's standpoint, this problem manifests in consumer dissatisfaction, failure to develop repeat business and failure to maximize sales per visit. Ideally, advertising would serve to maximize the information that is made available to consumers so that they could make informed decisions, thereby improving their consumption choices, maximizing their satisfaction and improving their rate of return visits and per-visit expenditures.

While the existing online directory services have provided some advantages over print media to advertisers and consumers, they also have some severe limitations. In particular, the information content (bandwidth) of such online directories is still limited by the method of presenting data to the consumer. In particular, text is a notoriously poor method of conveying to a consumer the nuances of ambiance, flavor, environment and spirit of a particular establishment's product and service offerings. While mere words, or in some cases words and still photographs, may pique a consumer's interest in a particular establishment, they generally fail to permit the kind of discrimination that will maximize the consumer's interest, lead to an informed decision by the consumer, potentially enhance the consumer's satisfaction with the product or service, and ultimately improve the average repeat business by consumers and/or increase the average consumer's expenditures per visit. While photographs, and in particular color photographs, provide additional information to the consumer, the amount and type of information conveyed by still photographs is still limited. The paucity of information content is especially noticeable in the case of services, such as restaurants, hotels, resorts, etc. where a consumer's satisfaction with a particular service may be affected by multifarious factors that are difficult to adequately describe in words alone.

There is thus a need for an advertising directory accessible by computer (e.g. on the Internet or similar computer input-output device), that provides increased content bandwidth to consumers, thereby enhancing the consumer's choices, improving the consumer's ultimate satisfaction and ultimately improving the repeat business and per visit purchasing of the consumers.

There is also a need for an improved method of advertising that provides not only the ability to provide greater information bandwidth to the consumer and increased consumer information to the advertiser.

These and other needs are met by various embodiments of the invention, which are set forth herein.

### SUMMARY OF THE INVENTION

The foregoing and further needs are met by embodiments of the invention, which provide an improved directory for goods and services, which is accessible by means of the Internet or other suitable computer-based input-output device, for example, a mobile phone. The directory provides the consumer with a search engine that is adapted to search an advertiser database that contains records containing video files. The search engine returns an answer set in response to a consumer's query, and optionally answers from preferred advertisers. The answer set contains objects, such as thumbnails of individual video frames. The consumer then selects an object and views a video, which is provided from the database. The consumer also can have the option to provide feedback to the advertiser, obtain additional information regarding the advertiser and/or obtain incentives (such as coupons) to purchase the advertisers' products and/or services. The advertiser is benefited, not only in that a more informed consumer is more satisfied and ultimately is more likely to be a repeat customer and/or to increase his or her per visit expenditures, but also in that the consumer can provided feedback to the advertiser. The advertiser is thus able to collect valuable information regarding the consumer's tastes, likes, dislikes, age, marital status, etc., which allows the advertiser to better focus future advertising, improve product and service offerings, and in general better meet consumers' needs.

The foregoing and further needs are thus met by embodiments of the invention, which provide a method of providing advertising to a consumer, e.g. via an internet web page or other suitable computer interface. The method includes: (a) providing an advertiser database comprising a plurality of advertiser records, each advertiser record comprising a unique advertiser identifier, at least one video file and optionally additional advertising matter; (b) receiving from the consumer one or more search criteria; (c) providing the search criteria to a search engine that queries the advertiser database using the search criteria to provide an answer set comprising records meeting the search criteria; (d) displaying a representation of the answer set to the consumer, the representation containing at least one consumer-selectable object representing each record belonging to the answer set; (e) receiving from the consumer an indication of an object selected by the consumer; and (f) displaying to the consumer the video file from the record represented by the selected object.

The foregoing and additional embodiments are further met by embodiments of the invention provide a method of providing advertising to a consumer, e.g. via an internet web page or other suitable computer interface. The method includes: (a) providing an advertiser database comprising a plurality of advertiser records, each advertiser record comprising a unique advertiser identifier, at least one video file and optionally additional advertising matter; (b) receiving from the consumer one or more search criteria; (c) providing the search criteria to a search engine that queries the advertiser database using the search criteria to provide an answer set comprising records meeting the search criteria; (d) displaying a representation of the answer set to the consumer, the representation containing at least one consumer-selectable object representing each record belonging to the answer set; (e) receiving from the consumer an indication of an object selected by the consumer; and (f) displaying to the consumer the video file from the record represented by the selected object. In some embodiments, the further includes registering the consumer, comprising the steps of: (i) receiving from the consumer one or more pieces of consumer data; (ii) recording said consumer data in a consumer record on in a consumer database; (iii) assigning and recording in the consumer record a unique consumer identifier; and optionally (iv) receiving from the consumer a confidential password and recording the confidential password in the record in a non-advertiser accessible field.

Additional and further needs are met by embodiments of the invention, which provide a method of providing advertising to a consumer, e.g. via an Internet web page or other suitable user-computer interface. The method includes: (a) providing an advertiser database comprising a plurality of advertiser records, each advertiser record comprising a unique advertiser identifier, at least one video file and optionally additional advertising matter; (b) receiving from the consumer one or more search criteria; (c) providing the search criteria to a search engine that queries the advertiser database using the search criteria to provide an answer set comprising records meeting the search criteria; (d) displaying a representation of the answer set to the consumer, the representation containing at least one consumer-selectable object representing each record belonging to the answer set; (e) receiving from the consumer an indication of an object selected by the consumer; and (f) displaying to the consumer the video file from the record represented by the selected object. In some embodiments, the search criteria include one or more keywords provided by the consumer. In other embodiments, the search criteria include one or more selection categories are that are selected by the consumer from one or more drop-down menus. In some, more specific, embodiments, the search criteria can include one or more keywords provided by the consumer and one or more selection categories that are selected by the consumer.

Further needs are met by some embodiments of the invention, which provide a method of searching for a provider of a product or service, comprising: (a) providing one or more search criteria to a search engine adapted to query a database comprising two or more records, each record containing at least one video file a unique advertiser identifier and optionally additional advertiser data; (b) obtaining an answer set comprising at least one object associated with a record meeting the search criteria; (c) selecting an object from the answer set; and (d) viewing the video contained in the record associated with the selected object.

Additional needs are met by embodiments of the present invention, which provide a method of advertising, comprising: (a) creating a video file representing an advertiser's product or service; (b) causing the video file to be placed in a record that contains a unique advertiser identifier, one or more search fields containing consumer-searchable data and optionally additional advertising matter; (c) providing a search engine adapted to query said database using search criteria; (d) receiving search criteria as selected by a consumer and providing said search criteria to the search engine to produce an answer set containing objects associated with records meeting said search criteria; (e) displaying a representation of said answer set to the consumer; (f) receiving from the consumer an indication of a selection of an object from the answer set; and (g) displaying for the consumer a video file from the record associated with said object. In some embodiments, the representation of the answer set comprises at least one consumer-selectable object representing each record meeting the search criteria. In particular embodiments, at least one consumer-selectable object is a thumbnail image of a frame from the video file belonging to the record. In particular embodiments, the thumbnail image is a logo or sign representing the advertiser's product or service. In some embodiments, the method also comprises displaying for the consumer additional advertising matter.

The foregoing and further needs are met by embodiments of the invention, which provide a method of advertising, comprising: (a) registering a consumer; (b) providing to the consumer access to a search engine adapted to query a database containing two or more records, each record comprising a video file, a unique advertiser identifier and one or more consumer searchable fields; (c) receiving from the consumer one or more search criteria and causing the search engine to search the database for records containing said search criteria; (d) receiving from the search engine an answer set comprising one or more consumer-selectable objects, each object being associated with one of said records containing said search criteria, and displaying said objects to the consumer; (e) receiving from the consumer an indication of the object selected by the consumer; and (f) displaying to the consumer at least the video file from the record associated with the selected object. In some embodiments, the method further comprises displaying for the consumer additional advertising material. In some specific embodiments, registering the consumer comprises the steps of: (i) receiving consumer information; and (ii) entering the consumer information in a consumer record in a consumer database.

Further needs are met by some embodiments of the invention, which provide a system for advertising, comprising: (a) a database comprising two or more records, each record comprising at least one video file and optionally additional advertising material, advertiser identification data or both; (b) a search engine capable of querying said database based upon consumer-selected search criteria; (c) a consumer interface, comprising: (d) a search display adapted to provide consumer-designated search criteria to search engine to query the database using the consumer-designated search criteria; (e) an answer set display containing one or more consumer selectable objects, each object being associated with a record meeting the consumer-designated search criteria; and (f) a video display adapted to play the video contained within the consumer-selected record.

Thus, in specific embodiments according to the present invention, a TCP/IP based application readable by a computer including but not limited to the Internet infrastructure and/or the World Wide Web which contains a database of a plurality of video files in various formats that depict and describe a specific place, location and/or service and implements the procedure of searching and displaying for the said files with a user interface consisting of: three window frames and a plurality of panes within said window frames, displaying in the first window of the said window frames a search box for retrieving the indexed plurality of video files, in the second window of the said window frames the result of the search, and the third window of the said window frames the complete detail information for selected record.

In one embodiment of the present invention, there exists a database of plurality of video files in various formats which depict and describe a specific place, location and/or service and the video files consist of a plurality of shots depicting and describing the said place, location and/or service, beginning and ending with the sign and/or logo of each said place, location and/or service. In another embodiment, a window contains a user accessible search box. As the user performs a search, the second window of the said window frames displays those records of the plurality of video files that best match the search keyword(s) or the criteria selected by the user from the pre-populated drop downs. In still another embodiment, the records displayed in the second window of the said window frames are listed alongside a thumbnail representing a frame in the video that depicts the sign and/or logo of each specific place, location and/or service. In yet another embodiment, the third window of the said window frames contains a player for playback and control of the video file selected in the second window of the said window frames. In still another embodiment, in the third window of the said window frames a user selectable button allows the user to receive coupons and/or savings electronically via cell phones, PDAs and any other devices alike.

These and other objects, advantages and features of the present invention will become readily apparent to those skilled in the art from a study of the following description of the exemplary Preferred Embodiments when read in conjunction with the attached Drawing and appended claims.

### INCORPORATION BY REFERENCE

All publications and patent applications mentioned in this specification are herein incorporated by reference to the same extent as if each individual publication or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIGS. 1-3 are representative of the graphic user interface used for searching the database of plurality of video files which depict and describe a certain place, location and/or service in accordance with the present invention;

FIG. 4 is a representation of retrieval process of the video files on a server using a database application; and

FIG. 5 is a representation of one method of accessing the Video Directory

FIG. 6 is a representation of a search screen containing a map.

FIG. 7 is a representation of an answer screen containing a map with location bubbles designating locations of advertisers' places of business.

### DETAILED DESCRIPTION OF THE INVENTION

In some embodiments, the invention provides a method of providing advertising to a consumer, e.g. via an internet web page or other suitable computer interface. The method includes: (a) providing an advertiser database comprising a plurality of advertiser records, each advertiser record comprising a unique advertiser identifier, at least one video file and optionally additional advertising matter; (b) receiving from the consumer one or more search criteria; (c) providing the search criteria to a search engine that queries the advertiser database using the search criteria to provide an answer set comprising records meeting the search criteria; (d) displaying a representation of the answer set to the consumer, the representation containing at least one consumer-selectable object representing each record belonging to the answer set; (e) receiving from the consumer an indication of an object selected by the consumer; and (f) displaying to the consumer the video file from the record represented by the selected object. In some embodiments, the answer set comprises multiple records. In some embodiments, the answer set comprises multiple consumer selectable objects. In some embodiments, at least one consumer selectable object is a thumbnail image of a video frame from the video file. In some embodiments, the thumbnail image is video frame representing a logo or sign belonging to the advertiser. In some additional embodiments, the method further comprises receiving consumer data, e.g. directly from the consumer or through inference from one of the consumer's choices of search criteria, browser type, screen resolution, consumer location and IP address. In particular embodiments, the consumer data are stored in a consumer record in a consumer database. In specific embodiments, the method further comprises providing at least a portion of the consumer data to at least one advertiser. In further embodiments, the method further comprises providing the consumer with at least one purchase incentive, such as a coupon. In some such embodiments, the purchase incentive is provided to the consumer via email, conventional mail, printable HTML, cellular phone text message or multimedia message service (MMS). In some further embodiments of the invention, the method further comprises providing to the consumer additional advertising matter. In particular embodiments, the additional advertising matter is in the form of text, graphics or links. In specific embodiments, the text is an advertiser's name, an advertiser's location, a textual description of an advertiser's goods or services, directions to the advertiser's place of business, advertiser's contact information, advertiser's hours of operation, estimated costs of the advertiser's goods or services or one or more reviews of the advertiser's goods or services. For example, the additional advertising matter may be graphics selected from the advertiser's logo, photographs of the advertiser's goods, services or place of business, maps showing the advertiser's location, one or more member of the group consisting of links to dialog boxes for providing consumer feedback, links to an invitation to a third party, links to third party web sites, links to the advertiser's web site, links to maps, links to menus, links to other text files and links to web pages for adding the selected video to the consumer's favorites, links to printable coupons and coupon request web pages. In some embodiments, the method comprises receiving from a consumer a request for a purchase incentive and sending the purchase incentive to the customer. In particular embodiments, the purchase incentive is a coupon. In specific embodiments, the coupon is sent by electronic mail, conventional mail, printable HTML or text message. In some embodiments, the method comprises collecting from the consumer information and inserting the consumer information in a consumer record in a consumer database. Such consumer information may be one or more members of the group consisting of the consumer's name, the consumer's primary phone number, the consumer's secondary phone number, the consumer's fax number, the consumer's primary email address, the consumer's secondary email address, the consumer's residence address, the consumer's mailing address, the consumer's place of work, the address of the consumer's place of work, the consumer's date of birth, the consumer's age, the consumer's sex, the consumer's occupation, the consumer's marital status, the names, age and sex of the consumer's spouse, significant other and/or children, the consumer's dietary preferences, the consumer's pastime, the consumer's favorites, the consumer's music preferences, the consumer's reading preferences, the consumer's television preferences, the consumer's movie preferences, the consumer's personality, the consumer's education, the consumer's employment status, birthdates and anniversaries specified by the consumer (such as anniversaries important to the consumer), the consumer's comments on one or more advertisers, the consumer's choices of videos to view, the consumer's choices of incentives to receive, advertiser ratings and reward point balances by advertiser. In specific embodiments, the method further comprises providing at least some of said consumer information to an advertiser.

As used herein, the term “advertiser” applies to a supplier or a product or service that are offered to the public. The term “advertiser” includes, however, third parties acting on behalf of a provider of a product or service, such as a person acting in the capacity of an agent on behalf of a product or service provider, such as an advertising agency, a sales person, a booking agent, etc.

The term “consumer,” as used herein, is intended to include all persons, whether natural or at law, who are in the market purchase goods or services, generally whether or not a sale is actually made.

In some embodiments, the invention provides a method of providing advertising to a consumer, e.g. via an internet web page or other suitable computer interface. The method includes: (a) providing an advertiser database comprising a plurality of advertiser records, each advertiser record comprising a unique advertiser identifier, at least one video file and optionally additional advertising matter; (b) receiving from the consumer one or more search criteria; (c) providing the search criteria to a search engine that queries the advertiser database using the search criteria to provide an answer set comprising records meeting the search criteria; (d) displaying a representation of the answer set to the consumer, the representation containing at least one consumer-selectable object representing each record belonging to the answer set; (e) receiving from the consumer an indication of an object selected by the consumer; and (f) displaying to the consumer the video file from the record represented by the selected object. In some embodiments, the further includes registering the consumer, comprising the steps of: (i) receiving from the consumer one or more pieces of consumer data; (ii) recording said consumer data in a consumer record on in a consumer database; (iii) assigning and recording in the consumer record a unique consumer identifier; and optionally (iv) receiving from the consumer a confidential password and recording the confidential password in the record in a non-advertiser accessible field. In specific embodiments, the method further comprises, after a unique customer identifier is assigned to the customer and recorded in the consumer record, assigning to the customer an initial password, designating the initial password as the confidential password and sending the initial password to the customer. In some embodiments, the initial password is sent to the consumer at a consumer-identified electronic mail address. In other embodiments, the user may choose a consumer-specified password, which is activated by means of an activation email sent to the consumer's email address or by text message to the consumer's telephone. In some more particular embodiments, the method comprises receiving from the customer a new password, designating the new password as the confidential password and recording the confidential password in the record in a non-advertiser accessible field. In some particular embodiments, the method further comprises providing at least a portion of said consumer information (but not the consumer's confidential password) to an advertiser.

In some embodiments, the invention provides a method of providing advertising to a consumer, e.g. via an internet web page or other suitable computer interface. The method includes: (a) providing an advertiser database comprising a plurality of advertiser records, each advertiser record comprising a unique advertiser identifier, at least one video file and optionally additional advertising matter; (b) receiving from the consumer one or more search criteria; (c) providing the search criteria to a search engine that queries the advertiser database using the search criteria to provide an answer set comprising records meeting the search criteria; (d) displaying a representation of the answer set to the consumer, the representation containing at least one consumer-selectable object representing each record belonging to the answer set; (e) receiving from the consumer an indication of an object selected by the consumer; and (f) displaying to the consumer the video file from the record represented by the selected object. In some embodiments, the search criteria include one or more keywords provided by the consumer. In other embodiments, the search criteria include one or more selection categories are that are selected by the consumer from one or more drop-down menus. In some, more specific, embodiments, the search criteria can include one or more keywords provided by the consumer and one or more selection categories that are selected by the consumer. Specific selection categories that may be mentioned include: type of service, region, price ranges, hours of operation, ratings, etc.

In some embodiments, the invention provides a method of searching for a provider of a product or service, comprising: (a) providing one or more search criteria to a search engine adapted to query a database comprising two or more records, each record containing at least one video file a unique advertiser identifier and optionally additional advertiser data; (b) obtaining an answer set comprising at least one object associated with a record meeting the search criteria; (c) selecting an object from the answer set; and (d) viewing the video contained in the record associated with the selected object.

In some embodiments, the invention provides a method of advertising, comprising: (a) creating a video file representing an advertiser's product or service; (b) causing the video file to be placed in a record that contains a unique advertiser identifier, one or more search fields containing consumer-searchable data and optionally additional advertising matter; (c) providing a search engine adapted to query said database using search criteria; (d) receiving consumer-selected search criteria and providing said search criteria to the search engine to produce an answer set containing objects associated with records meeting said search criteria; (e) displaying a representation of said answer set to the consumer; (f) receiving from the consumer an indication of a selection of an object from the answer set; and (g) displaying for the consumer a video file from the record associated with said object. In some embodiments, the representation of the answer set comprises at least one consumer-selectable object representing each record meeting the search criteria. In particular embodiments, at least one consumer-selectable object is a thumbnail image of a frame from the video file belonging to the record. In particular embodiments, the thumbnail image is a logo or sign representing the advertiser's product or service. In some embodiments, the method also comprises displaying for the consumer additional advertising matter.

In some embodiments, the invention provides a method of advertising, comprising: (a) registering a consumer; (b) providing to the consumer access to a search engine adapted to query a database containing two or more records, each record comprising a video file, a unique advertiser identifier and one or more consumer searchable fields; (c) receiving from the consumer one or more search criteria and causing the search engine to search the database for records containing said search criteria; (d) receiving from the search engine an answer set comprising one or more consumer-selectable objects, each object being associated with one of said records containing said search criteria, and displaying said objects to the consumer; (e) receiving from the consumer an indication of the object selected by the consumer; and (f) displaying to the consumer at least the video file from the record associated with the selected object. In some embodiments, the method further comprises displaying for the consumer additional advertising material. In some specific embodiments, registering the consumer comprises the steps of: (i) receiving consumer information; and (ii) entering the consumer information in a consumer record in a consumer database. In some particular embodiments, the consumer information may include at least one member from the group consisting of: the consumer's name, the consumer's primary phone number, the consumer's secondary phone number, the consumer's fax number, the consumer's primary email address, the consumer's secondary email address, the consumer's residence address, the consumer's mailing address, the consumer's place of work, the address of the consumer's place of work, the consumer's date of birth, the consumer's age, the consumer's sex, the consumer's occupation, the consumer's marital status, the names, age and sex of the consumer's children, the consumer's dietary preferences, the consumer's pastime, the consumer's favorites, the consumer's music preferences, the consumer's reading preferences, the consumer's television preferences, the consumer's movie preferences, the consumer's education, the consumer's employment status, birthdates and anniversaries important to the consumer, the consumer's comments on one or more advertisers, the consumer's choices of videos to view, the consumer's choices of incentives to receive and ratings. In some embodiments, registering the consumer further comprises receiving from or assigning to the consumer a password and storing the password in the consumer record in a non-advertiser accessible field.

In some embodiments, the invention provides a system for advertising, comprising: (a) a database comprising two or more records, each record comprising at least one video file and optionally additional advertising material, advertiser identification data or both; (b) a search engine capable of querying said database based upon consumer-selected search criteria; (c) a consumer interface, comprising: (d) a search display adapted to provide consumer-designated search criteria to search engine to query the database using the consumer-designated search criteria; (e) an answer set display containing one or more consumer selectable objects, each object being associated with a record meeting the consumer-designated search criteria; and (f) a video display adapted to play the video contained within the consumer-selected record. In some embodiments, the video display is further adapted to display additional advertising material. In some particular embodiments, the consumer interface also comprises a registration display adapted to receive consumer information and store said consumer information in a consumer record in a consumer database. In some specific embodiments, the consumer information may include one or more members of the group consisting of: the consumer's name, the consumer's primary phone number, the consumer's secondary phone number, the consumer's fax number, the consumer's primary email address, the consumer's secondary email address, the consumer's residence address, the consumer's mailing address, the consumer's place of work, the address of the consumer's place of work, the consumer's date of birth, the consumer's age, the consumer's sex, the consumer's occupation, the consumer's marital status, the names, age and sex of the consumer's children, the consumer's dietary preferences, the consumer's pastime, the consumer's favorites, the consumer's music preferences, the consumer's reading preferences, the consumer's television preferences, the consumer's movie preferences, the consumer's education, the consumer's employment status, birthdates and anniversaries important to the consumer, the consumer's comments on one or more advertisers, the consumer's choices of videos to view, the consumer's choices of incentives to receive and ratings. In some embodiments, the system further comprises an advertiser interface adapted to provide to an advertiser at least some consumer information. In some embodiments, the consumer interface further comprises one or more items selected from consumer-selectable items and additional consumer viewable items. In some specific embodiments, at least one of said items is an additional consumer-viewable item, such as advertiser-specific text. Such advertiser-specific text may include at least one member of the group consisting of the advertiser's name, location, hours of operation, average prices, menu and directions. In some embodiments, at least one of said items is a consumer selectable item, such as a consumer-selectable item is a link, e.g. a hyperlink to a third party internet page, a consumer incentive page, a text file, a map page showing the advertiser's place of business, directions to the advertiser's place of business or both, a page showing one or more still pictures of the advertiser's product or service or an invitation page. In some embodiments, the text file contains a menu (e.g. for a restaurant), a catalog (e.g. for a product supplier) or other description of an advertiser's product or service offering. In some embodiments, the a consumer incentive page may provide a coupon or other incentive for the consumer to use the advertiser's product or service. In some embodiments, such a coupon is delivered to the consumer via electronic mail, conventional mail, HTML document or cell phone text message or multimedia messaging service (MMS). In some embodiments, and invitation page may be adapted to send a third party an invitation by electronic mail, voicemail text message or voice over internet protocol message. In other embodiments, the consumer interface further comprises at least one consumer selectable object associated with a preferred advertiser. The consumer selectable object may correspond to one or more search criteria selected by the consumer. In some embodiments, the object may be linked to a video file associated with the preferred advertiser. In some embodiments, the object may be a still photo, thumbnail a of still photo, video frame, thumbnail of a video frame, logo or text linked to a video file associated with the preferred advertiser. In some embodiments, the answer set display further displays at least one object associated with a preferred advertiser. In some specific embodiments, the object is linked to a video file associated with the preferred advertiser. In particular, the object may be a still photo, thumbnail a of still photo, video frame, thumbnail of a video frame, logo or text linked to a video file associated with the preferred advertiser.

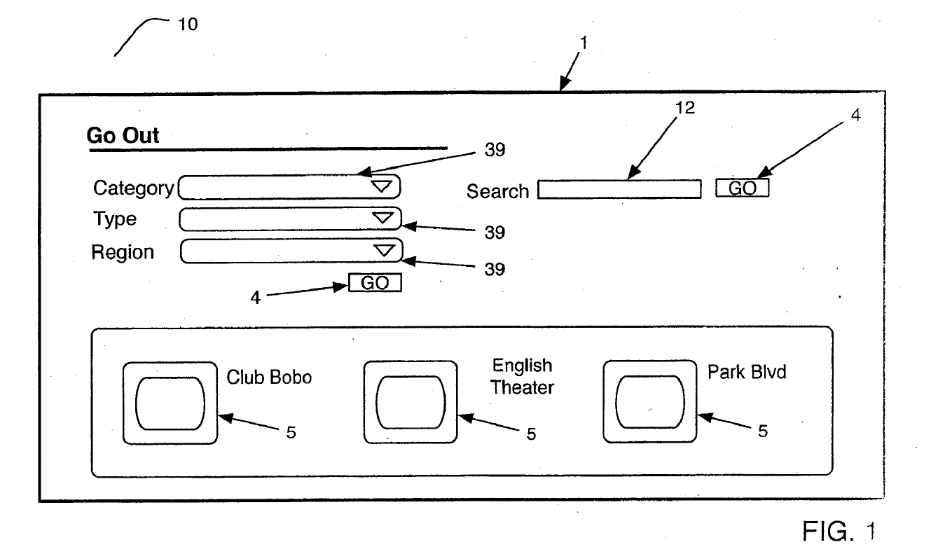

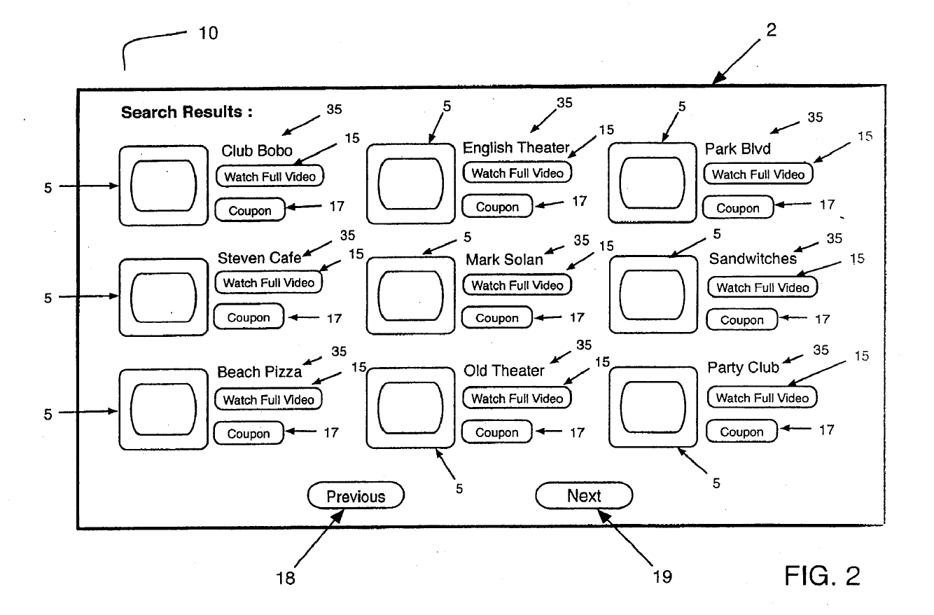

As best seen in FIG. 1, in accordance with another exemplary embodiment of the present invention, there is a search box 12 displayed in the first window 1 of the said window frames 10, where the user can input the search keyword and perform the search by selecting the Go button 4 which will initiate the search process of the database of plurality of video files based on the keyword(s) input by the user. In some embodiments, the search box may be accompanied by a visual search aid, such as a map. As also seen in FIG. 1, the user can perform a search by selecting criteria from pre-populated drop downs 39 and perform the search by selecting the Go button 4 which will initiate the search process of the database of plurality of video files based on the selected criteria in the pre-populated drop downs 39. Now referring to FIG. 2, the second window 2 of the said window frames 10 displays those records of the plurality of video files that best match the search keyword(s) or the criteria selected by the user from the pre-populated drop downs 39. In another exemplary embodiment of the present invention, the records displayed in the second window 2 of the said window frames 10 are listed alongside a thumbnail 5 representing a frame in the video that depicts the sign and/or logo of each specific place, location and/or service. The second window 2 of the said window frames 10 may include alongside of each search result: a Watch full Video button 15 to allow the user through the user interface to watch the video, and a Coupons button 17 to transmit savings and/or coupons electronically to the users cell phone, PDA and other devices alike. The second window 2 of the said window frames 10 may further include a Previous 18 and Next 19 buttons for allowing the user to go back and forth through the records displayed as the result of the search performed.

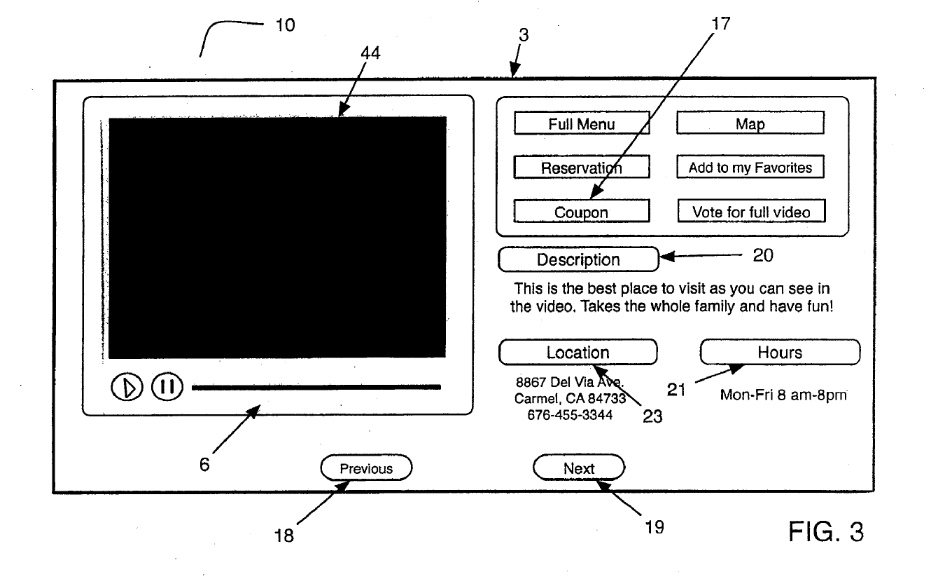

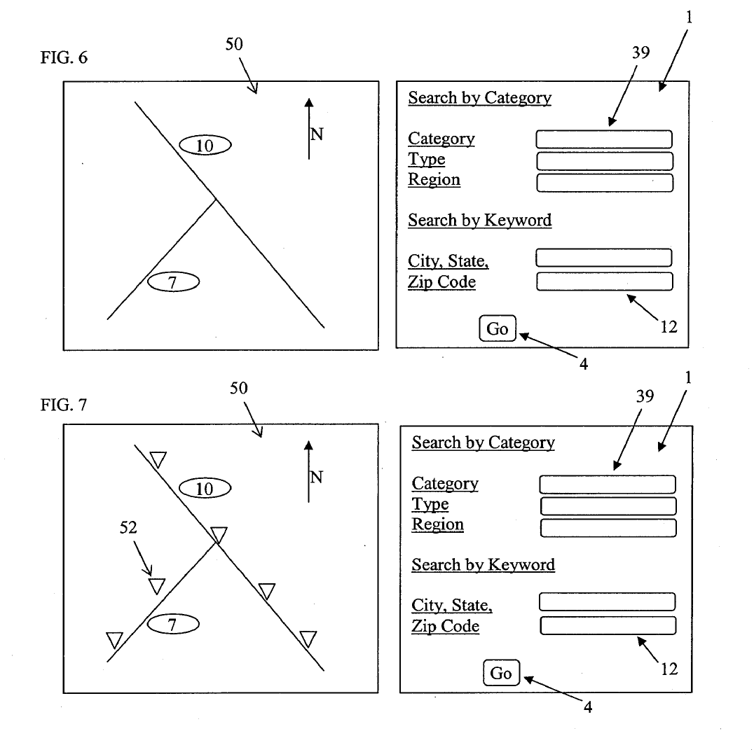

The page depicted in FIG. 2 is but one visual display of the search information that is possible with the present invention. For example, where the search terms chosen in FIG. 1 include location information, such as city, state and/or zip code, an intermediate results page may appear in which locations meeting the search terms included in the search that is run using the interface depicted in FIG. 1 will appear as balloons or bubbles on a map. Such an arrangement is depicted in FIG. 6 and 7. The first window 1 is accompanied by a map 50. In the first window 1, there are pre-populated dropdowns 39 and a go button 4. Selection of regional information from the pre-populated dropdowns 39 or search box 12 and clicking the go button 4 results in a map 50 being populated with one or more location indicia 52. Clicking on one of these indicia 52 will take the user to a search result page such a third window 3 depicted in FIG. 3. In alternative embodiments, clicking on the bubble may result in a video screen appearing in the middle of the map: i.e. the video will appear as a frame within the window containing the map.

In accordance with yet another exemplary embodiment of the present invention, as best seen in FIG. 3, the third window 3 of the window frames 10 includes a video player and controller 6 for the playback of the video file 44 of the selected place, location and/or service in the second window 2 of the window frames 10. In another accordance with the exemplary embodiment of the present invention, the third window 3 of the window frames 10 will include a Coupon button 17 for electronically transmitting coupons and/or savings to the users' cell phone, PDA, and other devices alike. In yet another embodiment of the present invention, a user selectable Previous button 18 and Next button 19, will allow the user to go back and forth through the detailed information of the records displayed in the second window 2 of the window frames 10. The third window 3 of the window frames 10 may also include user selectable buttons such as: Description button 20 which upon selection will reveal the description of the place, location and/or service depicted in the video, Location button 23 which upon selection will reveal the address and location information of the place, location and/or service, an Hours button 21 which upon selection will reveal the hours of operation for the specific place, location and/or service. The Description button 20, Location button 23 and Hours button 21 will be treated as selected when a user initially displays the third window 3 of the said window frames 10.

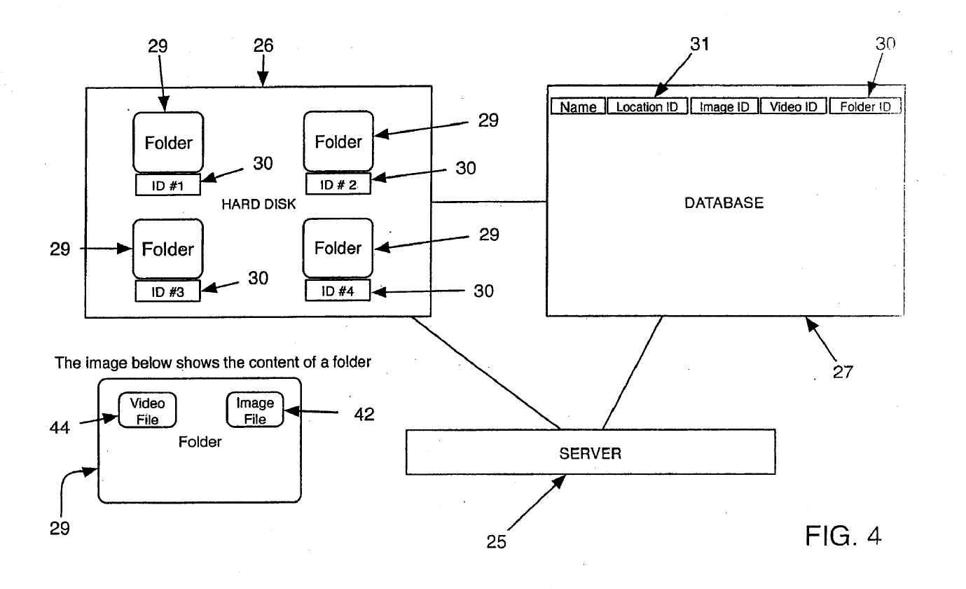

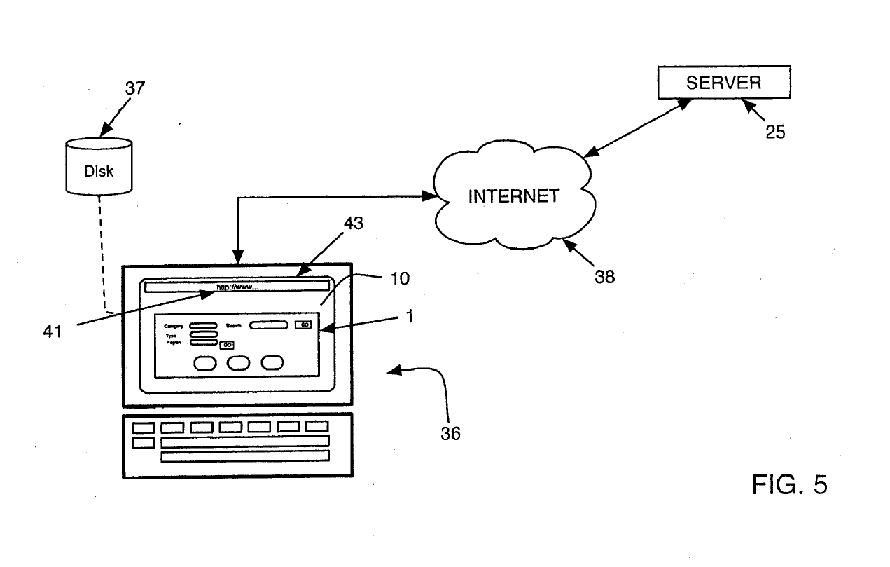

Referring now to FIG. 5, in a preferred embodiment of the present invention, the first window 1 of the said window frames 10 as best seen in FIG. 1 may be generated in an application such as a web browser 43 of a computer 36 as seen in FIG. 5. The computer 36 contains a computer readable medium, such as a disk 37, which contain as application code, such as a web browser. The code, when executed would allow the user to type in the direct web address 41 and communicate with the server 25, which contains the video files 44 and the database application 27 as seen in FIG. 4, through the Internet 3 8 and generate the first window 1 of the said window frames 10 and implement the following described procedures.

As seen in FIG. 4, in accordance with one exemplary embodiment of the present invention, there exists a database application 27 of plurality of unique folders 29 where each one contains a video file 44 which depicts a certain place, location and/or service. There exists a server 25, which contains a rewritable medium such as a hard disk 26, which unique folders 29 with assigned unique folder IDs 30 for each place, location and/or service are placed on. The database application 27 is run on the server and communicates with the first window 1, second window 2 and third window 3 of the said window frames 10. When a user performs a search in the first window 1 of the said window frames 10, as seen in FIG. I, a search query is sent to the database application 27 on the server 25. The database application 27 then identifies the query with certain location ID 31 which has a certain folder ID 30. Then database reads the image file 42 inside the folder 29 with the identified folder ID 30 in the database application 27, and displays the appropriate file on the second window 2 of the said window frames 10 as shown in FIG. 2. When a user in the second window 2 of the said window frames 10 selects a record 35, the database application 27 displays all the relative information to that specific place, location and/or service as best seen in FIG. 3 along with the video file 44 which is located in a specific folder 29 with a unique folder ID 30, for that specific record 35 on the third window 3 of the said window frames 10.

The provision of a coupon is merely one embodiment of incentives that may be offered to the customer by an advertiser. Other incentives that may be used include reward points. In some embodiments of the invention, one or more advertisers offer reward points for purchases made from the advertisers, for viewing one or more videos describing the advertiser's products and services, for providing feedback such as consumer ratings of advertisers' products and services, for recommending or referring other consumers to the advertisers' products and services, for inviting other potential consumers to meet at an advertiser's place of business, etc. In some currently preferred embodiments, no purchase is necessary to receive these promotional points. Advertisers may then permit consumers to redeem points for products or services, or for coupons redeemable for products or services from the advertiser. In some embodiments, there may be a direct correlation between the number of points and the cash value of the points. In some particular embodiments, a consumer may select a certain number of points to spend with a particular advertiser. Once the transaction is completed, a receipt for the expenditure is sent to the consumer, e.g. by electronic mail, overland mail, telephone text messaging or MMS.

In particular embodiments, the advertiser may change the points awarded for each expenditure with the advertiser as desired to improve repeat sales to consumers. In some embodiments, the advertiser or service provider may increase the number of points awarded per dollar of sales as various levels of purchasing are achieved by the consumer. In some currently preferred embodiments, the service provider makes the decision to award points on a points-per-dollar basis according to a pre-determined formula (say 100 points per dollar, 1000 points per dollar, etc.) In this way, advertisers may increase repeat sales and volume of sales per purchase event.

Advertisers may pay for the advertising service on a periodic basis or may pay per viewing of their video, per incentive delivered to users, per phone call the advertiser receives from the service provider, etc.

In some particular embodiments of the invention, the service provider provides a database on one or more servers that contains the advertisers' information, including the video files to be viewed by customers. In specific embodiments, the service provider may produce the video for a low set charge or for no charge. In such particular embodiments, the advertiser would then pay either a monthly service fee or a per usage fee, such as a fee every time the advertiser's video is viewed by a consumer or every time an incentive is delivered to a consumer.

In some embodiments, the advertiser also receives information describing the consumers of its services, such as personal information and/or demographic information. In some such embodiments, the advertiser pays for such information on a per consumer basis. In other embodiments, the advertiser may pay for periodic (e.g. monthly or yearly) access to such information. In some embodiments, demographic information may be presented in the form of graphs, charts, maps or other means of depicting the usage patterns of the consumer.

In some embodiments, the advertiser's video may be linked to a pre- or post-streamed video. In some embodiments, for example, a national, regional or international product or service provider may provide a link from its own video to a video depicting the products or services of a local provider. For example, a national restaurant or hotel chain may provide a national advertisement video that is then linked to a local provider, such as a local restaurant or hotel belonging to the chain. In other cases, a local provider may provide a link to a video provided by a national, regional or international provider. The linked video may appear before or after the video belonging to the advertiser whose record has been accessed. Thus, a local provider may be able to show a video for a national, regional or international chain, for example, which may appear before or after the local provider's own video. Thus, a local advertiser may be able to participate in a chain's promotional programs, thereby leveraging the advertising efforts of the chain to the local advertiser's benefit. In other embodiments, a chain may provide a pre- or post-streaming video link to a local associate, e.g. using the consumer's residence or work address and/or other consumer information to select the local advertiser whose video is to be shown. In this way a chain can provide support for multiple local providers, thereby enhancing their advertising efforts.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A method of providing advertising to a consumer, comprising:
(a) providing an advertiser database comprising a plurality of advertiser records, each advertiser record comprising a unique advertiser identifier, at least one video file and optionally additional advertising matter;
(b) receiving from the consumer one or more search criteria;
(c) providing the search criteria to a search engine that queries the advertiser database using the search criteria to provide an answer set comprising records meeting the search criteria;
(d) displaying a representation of the answer set to the consumer, the representation containing at least one consumer-selectable object representing each record belonging to the answer set;
(e) receiving from the consumer an indication of an object selected by the consumer; and
(f) displaying to the consumer the video file from the record represented by the selected object.

2. The method of claim 1, wherein the answer set comprises multiple records.

3. The method of claim 1, wherein the answer set comprises multiple consumer selectable objects.

4. The method of claim 3, wherein at least one consumer selectable object is a thumbnail image of a video frame from the video file.

5. The method of claim 4, wherein the thumbnail image is a video frame representing a logo or sign belonging to the advertiser.

6. The method of claim 1 further comprising receiving consumer data.

7. The method of claim 6, wherein the consumer data are stored in a consumer record in a consumer database.

8. The method of claim 7, further comprising providing at least a portion of the consumer data to at least one advertiser.

9. The method of claim 1, further comprising providing to the consumer at least one purchase incentive.

10. The method of claim 9, wherein the purchase incentive is a coupon.

11. The method of claim 10, wherein the purchase incentive is provided to the consumer via email, conventional mail, printable HTML, cellular phone text message or multimedia message service (MMS).

12. The method of claim 1, further comprising providing to the consumer additional advertising matter.

13. The method of claim 12, wherein said additional advertising matter is in the form of text, graphics or links.

14. The method of claim 13, wherein the text is an advertiser's name, an advertiser's location, a textual description of an advertiser's goods or services, directions to the advertiser's place of business, advertiser's contact information, advertiser's hours of operation, estimated costs of the advertiser's goods or services or one or more reviews of the advertiser's goods or services, or any combination of the above.

15. The method of claim 13, wherein the additional advertising matter is graphics selected from the group consisting of the advertiser's logo, photographs of the advertiser's goods, services or place of business, maps showing the advertiser's location, and combinations thereof.

16. The method of claim 13, wherein the additional advertising matter comprises one or more members of the group consisting of links to dialog boxes for providing consumer feedback, links to an invitation to a third party, links to third party web sites, links to the advertiser's web site, links to maps, links to menus, links to other text files and links to web pages for adding the selected video to the consumer's favorites, links to printable coupons and coupon request web pages.

17. The method of claim 1, further comprising receiving from a consumer a request for a purchase incentive and sending the purchase incentive to the customer.

18. The method of claim 17, wherein the purchase incentive is a coupon.

19. The method of claim 18, wherein the coupon is sent by electronic mail, conventional mail, printable HTML or text message.

20. The method of claim 19, further comprising collecting from the consumer information and inserting the consumer information in a consumer record in a consumer database.

21. The method of claim 20, wherein said consumer information is one or more members of the group consisting of the consumer's name, the consumer's primary phone number, the consumer's secondary phone number, the consumer's fax number, the consumer's primary email address, the consumer's secondary email address, the consumer's residence address, the consumer's mailing address, the consumer's place of work, the address of the consumer's place of work, the consumer's date of birth, the consumer's age, the consumer's sex, the consumer's occupation, the consumer's marital status, the names, age and sex of the consumer's spouse, significant other and/or children, the consumer's dietary preferences, the consumer's pastime, the consumer's favorites, the consumer's music preferences, the consumer's reading preferences, the consumer's television preferences, the consumer's movie preferences, the consumer's education, the consumer's employment status, birthdates and anniversaries specified by the consumer, the consumer's comments on one or more advertisers, the consumer's choices of videos to view, the consumer's choices of incentives to receive, advertiser ratings and reward point balances by advertisers.

22. The method of claim 21, further comprising providing at least some of said consumer information to an advertiser.

23. The method of claim 1, further comprising registering the consumer, comprising the steps of:
(i) receiving from the consumer one or more pieces of consumer data;
(ii) recording at least one piece of said consumer data in a consumer record in a consumer database;
(iii) assigning and recording in the consumer record a unique consumer identifier; and optionally receiving from the consumer a confidential password and recording the confidential password in the record in a non-advertiser accessible field.

24. The method of claim 23, further comprising, after a unique customer identifier is assigned to the customer and recorded in the consumer record, assigning to the customer an initial password, designating the initial password as the confidential password and sending the initial password to the customer.

25. The method of claim 24, wherein the initial password is sent to the customer at a customer-identified electronic mail address.

26. The method of claim 24, further comprising receiving from the customer a new password, designating the new password as the confidential password and recording the confidential password in the record in a non-advertiser accessible field.

27. The method of claim 23, further comprising providing at least a portion of said consumer information to an advertiser.

28. The method of claim 1, wherein the search criteria include one or more keywords provided by the consumer.

29. The method of claim 1, wherein the search criteria include one or more selection categories are that are selected by the consumer from one or more drop-down menus.

30. The method of claim 1, wherein the selection categories include at least one member of the group consisting of: type of service, region, price ranges, hours of operation and consumer ratings.

31. A method of searching for a provider of a product or service, comprising:
(a) providing one or more search criteria to a search engine adapted to query a database comprising two or more records, each record containing at least one video file, a unique advertiser identifier and optionally additional advertiser data;
(b) obtaining an answer set comprising at least one object associated with a record meeting the search criteria;
(c) selecting an object from the answer set; and
(d) viewing the video contained in the record associated with the selected object.

32. A method of advertising, comprising:
(a) creating a video file representing an advertiser's product or service;
(b) causing the video file to be placed in a record that contains a unique advertiser identifier, one or more search fields containing consumer-searchable data and optionally additional advertising matter;
(c) providing a search engine adapted to query said database using search criteria;
(d) receiving search criteria as selected by a consumer and providing said search criteria to the search engine to produce an answer set containing objects associated with records meeting said search criteria;
(e) displaying a representation of said answer set to the consumer;
(f) receiving from the consumer an indication of a selection of an object from the answer set; and
(g) displaying for the consumer a video file from the record associated with said object.

33. The method of claim 32, wherein the representation of said answer set comprises at least one consumer-selectable object representing each record meeting the search criteria.

34. The method of claim 33, wherein at least one consumer-selectable object is a thumbnail image of a frame from the video file belonging to the record.

35. The method of claim 34, wherein the thumbnail image is a logo or sign representing the advertiser's product or service.

36. The method of claim 32, further comprising displaying for the consumer additional advertising matter.

37. A method of advertising, comprising:
(a) registering a consumer;
(b) providing to the consumer access to a search engine adapted to query a database containing two or more records, each record comprising a video file, a unique advertiser identifier and one or more consumer searchable fields;
(c) receiving from the consumer one or more search criteria and causing the search engine to search the database for records containing said search criteria;
(d) receiving from the search engine an answer set comprising one or more consumer-selectable objects, each object being associated with one of said records containing said search criteria, and displaying said objects to the consumer;
(e) receiving from the consumer an indication of the object selected by the consumer; and
(f) displaying to the consumer at least the video file from the record associated with the selected object.

38. The method of claim 37, further comprising displaying for the consumer additional advertising material.

39. The method of claim 37, wherein registering the consumer comprises the steps of:
(a) receiving consumer information; and
(b) entering the consumer information in a consumer record in a consumer database.

40. The method of claim 39, wherein the consumer information includes at least one of the group consisting of the consumer's name, the consumer's primary phone number, the consumer's secondary phone number, the consumer's fax number, the consumer's primary email address, the consumer's secondary email address, the consumer's residence address, the consumer's mailing address, the consumer's place of work, the address of the consumer's place of work, the consumer's date of birth, the consumer's age, the consumer's sex, the consumer's occupation, the consumer's marital status, the names, age and sex of the consumer's spouse, significant other and/or children, the consumer's dietary preferences, the consumer's pastime, the consumer's favorites, the consumer's music preferences, the consumer's reading preferences, the consumer's television preferences, the consumer's movie preferences, the consumer's education, the consumer's employment status, birthdates and anniversaries specified by the consumer, the consumer's comments on one or more advertisers, the consumer's choices of videos to view, the consumer's choices of incentives to receive, advertiser ratings and reward point balances by advertisers.

41. The method of claim 40, wherein registering the consumer further comprises receiving from or assigning to the consumer a password and storing the password in the consumer record in a non-advertiser accessible field.

42. A system for advertising, comprising:
(a) a database comprising two or more records, each record comprising at least one video file and optionally additional advertising material, advertiser identification data or both;
(b) a search engine capable of querying said database based upon consumer-selected search criteria;
(c) a consumer interface, comprising:
(i) a search display adapted to provide consumer-designated search criteria to the search engine to query the database using the consumer-designated search criteria;
(ii) an answer set display containing one or more consumer selectable objects, each object being associated with a record meeting the consumer-designated search criteria; and
(iii) a video display adapted to play the video contained within the consumer-selected record.

43. The system of claim 42, wherein the video display is further adapted to display additional advertising material.

44. The system of claim 43, wherein the consumer interface also comprises a registration display adapted to receive consumer information and store said consumer information in a consumer record in a consumer database.

45. The system of claim 44, wherein the consumer information includes one or more members of the group consisting of the consumer's name, the consumer's primary phone number, the consumer's secondary phone number, the consumer's fax number, the consumer's primary email address, the consumer's secondary email address, the consumer's residence address, the consumer's mailing address, the consumer's place of work, the address of the consumer's place of work, the consumer's date of birth, the consumer's age, the consumer's sex, the consumer's occupation, the consumer's marital status, the names, age and sex of the consumer's spouse, significant other and/or children, the consumer's dietary preferences, the consumer's pastime, the consumer's favorites, the consumer's music preferences, the consumer's reading preferences, the consumer's television preferences, the consumer's movie preferences, the consumer's education, the consumer's employment status, birthdates and anniversaries specified by the consumer, the consumer's comments on one or more advertisers, the consumer's choices of videos to view, the consumer's choices of incentives to receive, advertiser ratings and reward point balances by advertisers.

46. The system of claim 45, further comprising an advertiser interface adapted to provide to an advertiser at least some of said consumer information.

47. The system of claim 42, wherein the consumer interface further comprises one or more items selected from consumer-selectable items and additional consumer viewable items.

48. The system of claim 47, wherein at least one of said items is an additional consumer-viewable item.

49. The system of claim 48, wherein the consumer-viewable item is advertiser-specific text.

50. The system of claim 49, wherein the advertiser-specific text contains at least one member of the group consisting of the advertiser's name, location, hours of operation, average prices, menu and directions to the advertiser's location.

51. The system of claim 47, wherein at least one of said items is a consumer selectable item.

52. The system of claim 51, wherein the consumer-selectable item is a link.

53. The system of claim 52, wherein the link is a hyperlink to a third party internet page, a consumer incentive page, a map page showing the advertiser's place of business, directions to the advertiser's place of business or both, a page showing one or more still pictures of the advertiser's product or service or an invitation page.

54. The system of claim 53, wherein the consumer incentive page provides a coupon.

55. The system of claim 54, wherein the coupon is delivered to the consumer via electronic mail, conventional mail, HTML document or cell phone text message or multimedia messaging service (MMS).

56. The system of claim 53, wherein the invitation page is adapted to send a third party an invitation by electronic mail, voicemail, text message or voice over internet protocol message.

57. The system of claim 42, wherein the consumer interface further comprises at least one consumer selectable object associated with a preferred advertiser.

58. The system of claim 57, wherein the consumer selectable object corresponds to one or more search criteria selected by the consumer.

59. The system of claim 57, wherein the object is linked to a video file associated with the preferred advertiser.

60. The system of claim 59, wherein the object is a still photo, thumbnail of a still photo, video frame, thumbnail of a video frame, logo or text linked to a video file associated with the preferred advertiser.

61. The system of claim 42, wherein the answer set display further displays at least one object associated with a preferred advertiser.

62. The system of claim 61, wherein the object is linked to a video file associated with the preferred advertiser.

63. The system of claim 50, wherein the object is a still photo, thumbnail of a still photo, video frame, thumbnail of a video frame, logo or text linked to a video file associated with the preferred advertiser.
